(19) United States
(12) Patent Application Publication
(10) Pub. No.: US 2017/0320587 A1
(43) Pub. Date: Nov. 9, 2017

(54) Method And System For The Circulation Of Fuel In An Aircraft

(71) Applicant: Zodiac Aerotechnics, Roche la Moliere (FR)

(72) Inventors: Florian Dumas, Saint-Etienne (FR); Nicolas Travers, Saint-Just-Malmont (FR)

(21) Appl. No.: 15/512,961

(22) PCT Filed: Sep. 22, 2015
(86) PCT No.: PCT/FR2015/052532

§ 371 Date: Mar. 21, 2017

(30) Foreign Application Priority Data
Sep. 24, 2014 (FR) 1458982

(51) Int. Cl. B64D 37/00; B64D 37/16; B64D 41/00; F04B 43/02

(52) U.S. Cl. CPC B64D 37/005; F04B 43/02; B64D 37/16; B64D 41/00

(57) ABSTRACT

A method for the circulation of fuel in an aircraft uses at least one diaphragm pump having an undulating diaphragm that can undulate between two flanges, under the action of an actuator, for circulating the fuel between an admission line of the pump and an exhaust line of the pump.

### FIELD OF THE INVENTION

The present invention relates to a method and a system for the circulation of fuel in an aircraft, such as an airplane for example.

### BACKGROUND OF THE INVENTION

In the domain of aeronautics, it is well known to make fuel circulate in an aircraft either from external equipment for refueling, or from internal equipment to distribute the fuel among different tanks (transfer), and/or to supply the engines such as the jets of the airplane or at least an auxiliary power unit (APU) with the fuel necessary for their operation (supply).

The refueling of an aircraft is an operation performed to place the amount of fuel on board needed for the next flight from a pressurized line from a truck (+/−100 m³/h at 0.25 MPa (2.5 bars)). This operation is also called “pressure refuel.”

The transfer of fuel is a necessary operation in aircraft if they have more than one tank. The number of tanks varies among aircraft manufacturers and the configuration of the model in question, and an emptying sequence is compulsory. In particular, the transfer of fuel can take place during filling of the manifold, also called “Scavenge,” which is continuously supplied at a flow rate greater than the consumption of the engines. The objective is to keep the manifold 100% full and with an overflow into another tank in order to ensure a good supply to the engines, irrespective of the roll and/or pitch flight conditions of the aircraft. The transfer of fuel can also take place either during the transfer of fuel between two tanks situated on each side of the airplane to reestablish the center of gravity in the event of overconsumption of one of the engines, and/or shutdown of one of the engines, and/or non-homogeneous filling of the tanks of the airplane, which would cause an imbalance of the airplane on one side or the other, or during the possible transfer of fuel from a rear tank, also called AFT tank, and/or from a forward tank, also called FWD tank, and/or from a central tank, also called CTR tank, in order to optimize the position of the center of gravity of the airplane which influences the aerodynamic characteristics of the flight and thus the resulting consumption of fuel.

The supply of fuel to the engines is achieved by a fuel pump that draws the fuel from the manifold to send it to the engine. There is generally one fuel pump per engine, and one standby pump per side, which are located at the bottom of the tank(s). They can be installed in a disassembly housing to enable their maintenance without having to empty the tanks.

Thus, the circulation of fuel in an aircraft is performed by means of rotodynamic pumps such as turbopumps and/or volumetric pumps for example, supplied by electrical or hydraulic power, or in Venturi effect pumps (ejectors) supplied by an actuation pressure.

The rotodynamic pumps most often used in the fuel systems of an aircraft are turbopumps, also called centrifugal pumps, which comprise a pump body composed primarily of a suction pipe, a housing and a discharge pipe. The housing receives the movable part or rotor which is formed of the impeller, said impeller being in the form of a bladed wheel mounted on a shaft. The rotor is actuated by a drive machine which can be an electric or hydraulic or thermal or turbine motor.

This type of pump has numerous disadvantages. Indeed, in general this type of pump has poor energy performance, on the order of 30 to 70%, as well as significant weight and space requirements, serious wear of rotational parts requiring frequent maintenance and sensitivity to the cavitation phenomenon. Cavitation is a noisy phenomenon that can destroy a machine in a few minutes. During pumping, the liquid situated inside a centrifugal pump does not have uniform pressure, In particular, there are areas in which low pressures are more or less accentuated. When the pumped liquid is sufficiently close to its boiling point, i.e. the point of changeover from liquid state to gaseous state, it may occur that the pressure at said points falls below its vaporizing pressure, causing vapor bubbles to be formed in the pump. When said bubbles reach areas where the pressure increases, they suddenly implode. The implosion is accompanied by noise, and if it occurs in the vicinity of a wall, it is likely to cause mechanical damage producing micro-perforations in the metal (erosion).

The other pumps utilized in a fuel supply system of an aircraft are Venturi-effect pumps; however, said Venturi-effect pumps require the use of another type of pump to generate the actuation pressure, which increases the weight of the unit. Moreover, said pumps have a very low energy efficiency, on the order of 10 to 25%, and are sensitive to the cavitation phenomenon.

In the application in question, the cavitation phenomena are very detrimental for equipment called “sensitive” to this phenomenon, because they cause mechanical degradation of the equipment, degradation of performance, noise and in some cases the introduction of gas bubbles that can be problematic for the jet engines of an airplane. In aeronautics, the conditions that lead to cavitation are the type of fuel with a density specific to each fuel, low atmospheric pressure, i.e. when the aircraft is at high altitude, a high temperature of the fluid which facilitates the changeover from liquid state to gaseous state, and a high speed of the fluid.

There is therefore a real need for an aircraft fuel supply system having good energy efficiency, low weight and small space requirement, requiring less maintenance and being insensitive to the cavitation phenomena which can appear depending in particular on flight conditions.

### SUMMARY OF THE INVENTION

One of the purposes of the invention, therefore, is to remedy these disadvantages by proposing a method and system for the circulation of fuel in an aircraft having good efficiency, requiring less maintenance, and being insensitive to the cavitation phenomenon.

To that end, and in accordance with the invention, a remarkable method is proposed consisting of utilizing at least one undulating diaphragm pump capable of undulating, under the action of actuating means, between two flanges to cause said fuel to circulate between an admission line of the pump and an exhaust line of the pump.

Compared to the fuel circulation methods of the prior art, less maintenance is obtained due to the absence of rotating parts in the diaphragm pump and a high level of tolerance to the phenomena of cavitation and pollution. Moreover, the implementation of the fuel circulation method is facilitated because the diaphragm pump allows a self-priming of the pump.

The method according to the invention can be presented according to several particular embodiments. Indeed, a first embodiment consists in using the at least one diaphragm pump with its admission line connected to an external source of fuel supply, and with its exhaust line connected to a tank of the aircraft in order to fill it with fuel.

A second embodiment consists in using the at least one diaphragm pump with its admission line connected to a tank, and with its exhaust line connected to another tank of the aircraft in order to transfer fuel between said tanks.

A third embodiment consists in using the at least one diaphragm pump with its admission line connected to a tank, and with its exhaust line connected to an engine of the aircraft in order to supply it with fuel.

A fourth embodiment consists in using the at least one diaphragm pump with its admission line connected to a tank, and with its exhaust line connected to an auxiliary power unit of the aircraft in order to supply it with fuel.

Finally, a fifth embodiment consists in using the at least one diaphragm pump with its admission line connected to a tank, and with its exhaust line connected to an external source for receiving fuel in order to empty the tank.

An improvement is also made to a fuel circulation system in an aircraft that is remarkable in that it comprises at least one undulating diaphragm pump capable of undulating, under the action of actuating means, between two flanges for circulating said fuel between an admission line of the pump and an exhaust line of the pump.

Compared to the fuel circulation systems of the prior art, less maintenance is obtained due to the absence of rotating parts in the diaphragm pump and a high level of tolerance to the phenomena of cavitation and pollution. Moreover, the implementation of the fuel circulation system is facilitated because the diaphragm pump allows self-priming of the pump.

According to a first embodiment, the admission line of the diaphragm pump is connected to an external fuel supply source, and the exhaust line is connected to a tank of the aircraft in order to fill it with fuel.

According to a second embodiment, the admission line of the diaphragm pump is connected to a tank, and the exhaust line is connected to another tank of the aircraft in order to transfer the fuel between said tanks.

According to a third embodiment, the admission line of the diaphragm pump is connected to a tank, and the exhaust line is connected to an engine of the aircraft in order to supply it with fuel.

According to a fourth embodiment, the admission line of the diaphragm pump is connected to a tank, and the exhaust line is connected to an auxiliary power unit of the aircraft in order to supply it with fuel.

Finally, according to a fifth embodiment, the admission line of the diaphragm pump is connected to a tank, and the exhaust line thereof is connected to an external source of receiving fuel in order to empty the tank.

### BRIEF DESCRIPTION OF THE DRAWINGS

Other advantages and characteristics will be seen from the following description of various embodiments, provided by way of non-limiting examples, of the pump and of the fuel supply system of an aircraft according to the invention, with reference to the appended drawings in which:

FIG. 1 is a schematic representation of the fuel circulation method and system according to the invention for filling the tanks of an aircraft.

FIG. 2 is a schematic representation of the fuel circulation method and system according to the invention for the transfer of fuel from a first tank to a second tank of an aircraft.

FIG. 3 is a schematic representation of the fuel circulation method and system according to the invention for supplying fuel to the jets of an aircraft.

FIG. 4 is a schematic representation of the fuel circulation method and system according to the invention for supplying fuel to an auxiliary power unit (APU) of an aircraft.

FIG. 5 is a schematic representation of the fuel circulation method and system according to the invention for emptying tanks of an aircraft.

FIG. 6 is a side view of a first variant of an embodiment of the pump implemented in the method of the invention.

FIG. 7 is a side view of a second variant of an embodiment of the pump implemented in the method of the invention.

FIG. 8 is a side view of a third variant of an embodiment of the pump implemented in the method of the invention.

### DETAILED DESCRIPTION OF THE INVENTION

In the following description of the fuel circulation method and system in an aircraft according to the invention, the same numerical references designate the same elements. Furthermore, the views are not necessarily drawn to scale.

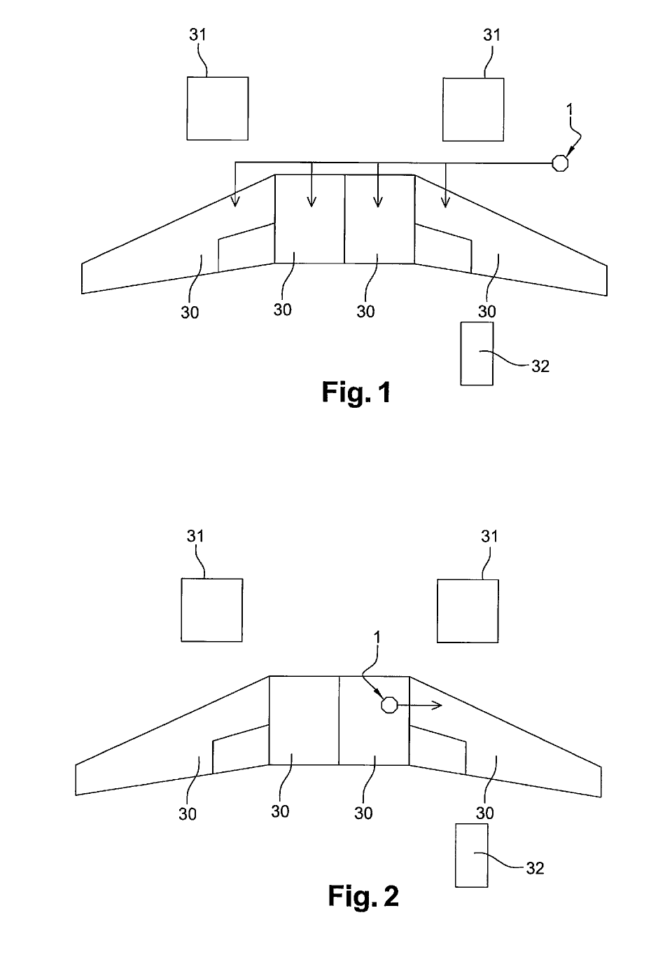

With reference to FIGS. 1 to 5, the invention concerns a fuel circulation method and system in an aircraft. According to the invention, the method consists in using at least one undulating diaphragm pump (1) capable of undulating, under the action of actuating means, between two flanges for circulating said fuel between an admission line of the pump (1) and an exhaust line of the pump.

To that end, and with reference to FIGS. 1 to 8, the fuel circulation system comprises at least one diaphragm pump (1). According to one particular embodiment, the diaphragm pump comprises a cylindrical pump body (2) enclosing a cylindrical chamber into which an admission line (4) opens and an exhaust line (5) coaxial to the pump body (2), an undulating membrane comprising a central opening and extending into the cylindrical chamber between a fixed lower flange and a fixed upper flange, said flanges extending into said cylindrical chamber.

The undulating membrane is in the form of a disk having a circular central opening. The undulating membrane is obtained from deformable material such as a silicone elastomer for example or similar. The thickness of the undulating membrane increases from its central part to its peripheral edge, and the circular central opening has a diameter substantially equal to the inside diameter of the exhaust line (5).

The lower flange is integral to the bottom wall of the body (2) of the pump (1) and the upper flange is capable of being moved vertically in order to vary the pump displacement as will be detailed herein below. Moreover, the walls of the upper and lower flanges holding the membrane are convex.

Furthermore, the pump (1) comprises rigid means of support of the membrane between the upper and lower flanges. Said means of support cooperate in particular with the peripheral edge of the membrane. Said means of support consist, for example, of an annular collar supporting the peripheral edge of the membrane.

Moreover, the pump (1) comprises means of actuating the undulating membrane cooperating with the means of support thereof. Said actuating means consist, for example, of a linear electromagnetic actuator and damping means that limit the travel of the electromagnetic actuator.

The electromagnetic actuator itself consists of a movable cylindrical ring extending coaxially to the exhaust line (5) above the upper flange and in line with an excitation motor. The excitation motor is composed of a fixed cylindrical armature called internal, and a fixed cylindrical armature called external, supporting an annular coil and two annular permanent magnets extending above and respectively below the annular coil, said annular coil being connected to a power supply circuit. The power supply circuit comprises, for example, at least one power amplifier and a signal generator.

The lower end of the movable cylindrical ring is integral to an annular collar having a shoulder, and engaged with a connecting element integral to the support ring of the undulating membrane. Thus, the connecting element holds the undulating membrane particularly when the actuator is at rest.

Moreover, the upper flange is advantageously integral to a slide capable of sliding vertically with respect to the internal fixed armature in order to vary the displacement of said pump (1). Said slide consists, for example, of a circular part having a central recess for the passage of the exhaust line (5) and holes into which guides extend that are integral to the internal fixed armature. In order to change the position of said slide, it has threading cooperating with a screw extending into a hole made in the internal fixed armature. The screw consists of a tubular part of circular transverse cross-section having threading on its outer wall, at its lower part.

The upper flange is integral to the lower face of said slide in such a way that, by varying the position of said slide along the vertical axis of revolution of the pump (1), the displacement of the pump can be varied in accordance with the requirement of the application concerned.

In addition, the admission line (4) and/or the exhaust line (5) can comprise at least one filter.

Moreover, the pump according to the invention will advantageously comprise at least one sensor such as a pressure sensor and/or a temperature sensor and/or a fuel presence sensor. The information measured by said sensors can be transmitted to the supply circuit that may comprise management means for regulating the flow as a function of said information by modifying the power supply characteristics of the linear electromagnetic actuator in particular.

Thus, when the linear electromagnetic actuator is activated, the movable cylindrical ring is moved alternatively downwards and upwards, driving the undulating membrane downwards and respectively upwards at the frequency powering the linear electromagnetic actuator. In this way, the membrane propagates a wavefront that causes the displacement of the fuel present in the cylindrical chamber towards the exhaust line (5).

In other words, the fuel circulation system incorporates a positive displacement diaphragm pump (1) which utilizes the membrane in an alternating movement, wherein the fuel is moved by trapping a fixed quantity of fuel, and by forcing the discharge of the trapped volume through the exhaust line (5). The diaphragm pump (1) therefore comprises good suction properties.

The only movable part with which the fuel is in contact in the pump is the elastomer membrane. All of the mechanical and electrical components are isolated from exposure to the fuel. This makes it possible to minimize the risk of trapping foreign bodies and to maximize the reliability of the fuel circulation method and system according to the invention. Maintenance of the system is therefore reduced.

Several embodiment variations are possible for the arrangement of the admission line (4) with respect to the pump body (2). In effect, and according to a first variant illustrated in FIG. 6, the admission line (4) of the diaphragm pump (1) extends radially with respect to the pump body (1).

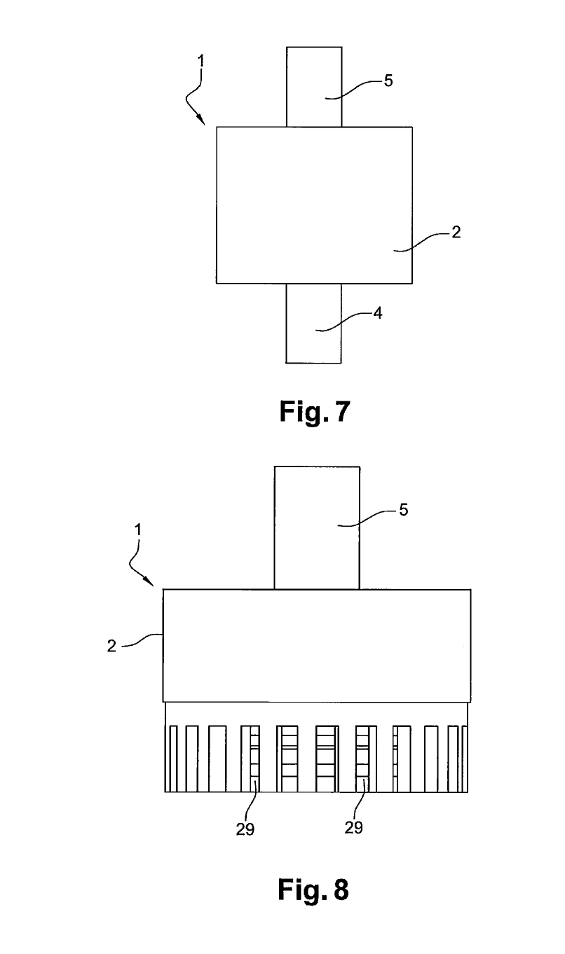

According to a second variant illustrated in FIG. 7, the admission line (4) extends from the side opposite to the exhaust line (5), and coaxially therewith.

Finally, according to a third variant illustrated in FIG. 8, the admission line (4) of the diaphragm pump (1) is in the form of a plurality of vents (29) formed in the cylindrical body (2) of the pump (1) in order to place the cylindrical chamber in communication with the exterior of the pump (1). In this particular embodiment, said vents (29) consist of longitudinal apertures uniformly distributed around the circumference of the cylindrical pump body (2) and extending over the full height of the cylindrical chamber.

It is obvious that the shape of the pump does not limit the invention, since said pump body (2), the chamber and the membrane can have any shape whatsoever, such as a parallelepiped shape for the pump body (2) and the chamber, and a rectangular shape for the membrane, without going beyond the scope of the invention. What is essential is the advantageous utilization of a diaphragm pump in a fuel circulation method in an aircraft.

Lastly, it is clear that the examples that have just been given are only specific illustrations and are by no means limiting as concerns the scope of the invention.

Based on the foregoing, the method according to the invention makes it possible to perform various fuel circulation operations in an aircraft by means of the diaphragm pump (1).

With reference to FIG. 1, the method according to the invention enables at least one of the tanks (30) of an aircraft to be filled with fuel. To that end, the admission line (4) of the diaphragm pump (1) of the circulation system is connected to an external fuel supply source, and the exhaust line (5) is connected to a tank (30) of the aircraft in order to fill it with fuel.

With reference to FIG. 2, the method makes it possible to transfer fuel between at least two tanks (30) of the aircraft. To that end, the admission line (4) of the diaphragm pump (1) of the circulation system is connected to one tank (30), and the exhaust line (5) is connected to another tank (30) of the aircraft in order to transfer fuel between said tanks (30).

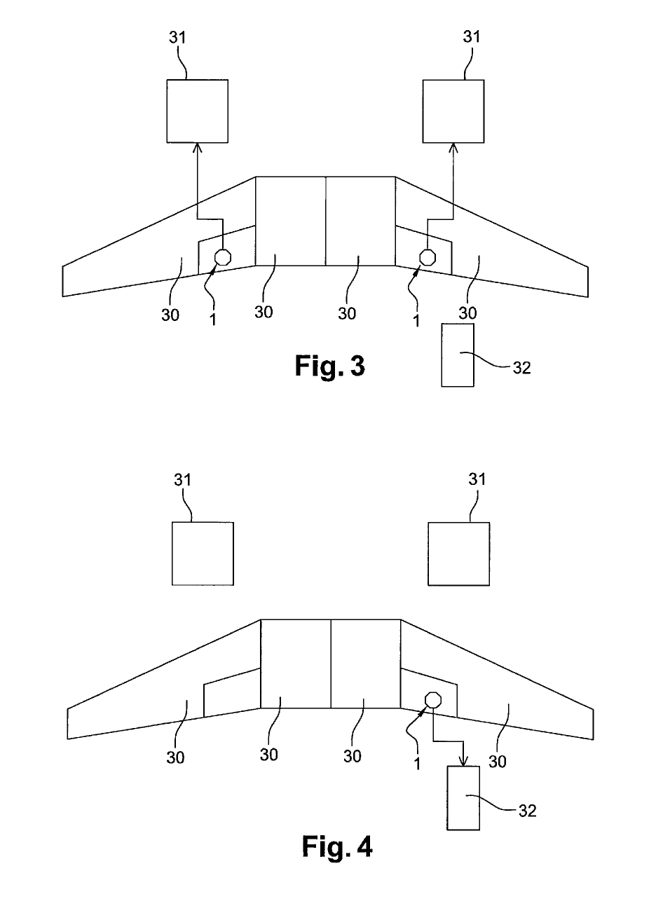

With reference to FIG. 3, the method also makes it possible to supply fuel to at least one of the engines (31), from at least one of the tanks (30). To that end, the admission line (4) of the diaphragm pump (1) of the circulation system is connected to a tank (30), and the exhaust line (5) is connected to an engine (31) of the aircraft in order to supply it with fuel.

With reference to FIG. 4, the method makes it possible to supply fuel to at least one auxiliary power unit (APU) from at least one of the tanks (30). To that end, the admission line (4) of the diaphragm pump (1) of the circulation system is connected to a tank (30), and the exhaust line (5) is connected to an auxiliary power unit (32) of the aircraft in order to supply it with fuel.

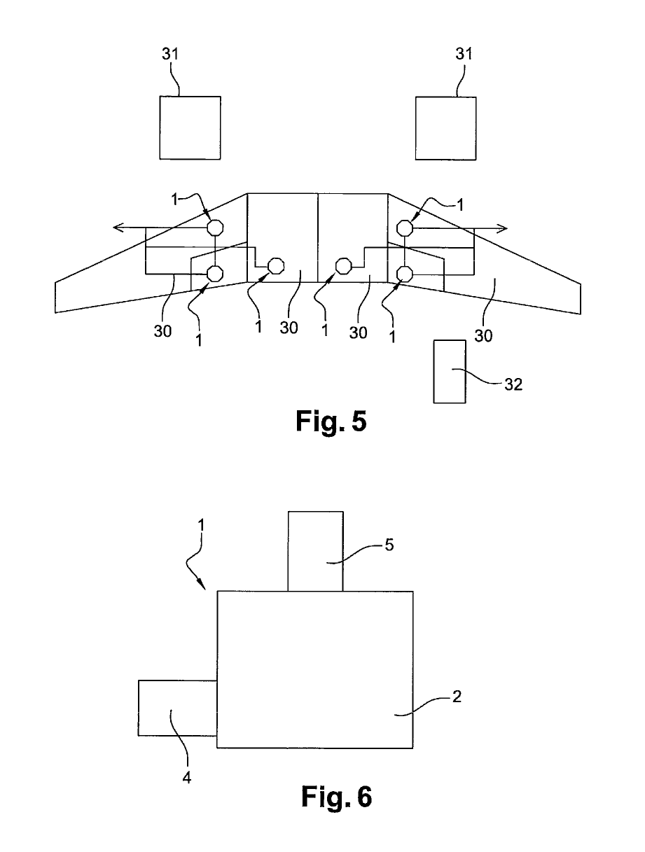

Finally, with reference to FIG. 5, the method according to the invention also enables at least one of the tanks (30) to be emptied. To that end, the admission line (4) of the diaphragm pump (1) of the circulation system is connected to a tank (30), and the exhaust line (5) is connected to an external source for receiving fuel in order to empty the tank (30).

It is quite obvious that the system can comprise as many diaphragm pumps (1) as there are different fuel circulation operations to be performed.

1. A fuel circulation method in an aircraft, characterized in that the fuel circulation method comprises the step of using at least one diaphragm pump having an undulating diaphragm that can undulate between two flanges, under the action of actuating means, for circulating said fuel between an admission line of the pump and an exhaust line of the pump.

2. The fuel circulation method according to claim 1, characterized in that the fuel circulation method further comprises the step of using the at least one diaphragm pump with the admission line connected to an external fuel supply source, and with the exhaust line connected to a tank of the aircraft for the filling thereof with fuel.

3. The fuel circulation method according to claim 1, characterized in that the fuel circulation method further comprises the step of using the at least one diaphragm pump with the admission line connected to a tank, and with the exhaust line connected to another tank of the aircraft in order to transfer fuel between said tanks.

4. The fuel circulation method according to claim 1, characterized in that the fuel circulation method further comprises the step of using the at least one diaphragm pump with the admission line connected to a tank, and with the exhaust line connected to an engine of the aircraft in order to supply the engine with fuel.

5. The fuel circulation method according to claim 1, characterized in that the fuel circulation method further comprises the step of using the at least one diaphragm pump with the admission line connected to a tank, and with the exhaust line connected to an auxiliary power unit of the aircraft in order to supply the auxiliary power unit with fuel.

6. The fuel circulation method according to claim 1, characterized in that the fuel circulation method further comprises the step of using the at least one diaphragm pump with the admission line connected to a tank, and with the exhaust line connected to an external source for receiving fuel in order to empty the tank.

7. A fuel circulation system in an aircraft, characterized in that the fuel circulation system comprises the step of using at least one undulating diaphragm pump capable of undulating, under the action of actuating means, between two flanges for circulating said fuel between an admission line of the pump and an exhaust line of the pump.

8. The fuel circulation system according to claim 7, characterized in that the admission line of the at least one diaphragm pump is connected to an external source of fuel supply, and the exhaust line is connected to a tank of the aircraft for the filling thereof with fuel.

9. The fuel circulation system according to claim 7, characterized in that the admission line of the at least one diaphragm pump is connected to a tank, and the exhaust line is connected to another tank of the aircraft in order to transfer fuel between said tanks.

10. The fuel circulation system according to claim 7, characterized in that the admission line of the at least one diaphragm pump is connected to a tank, and the exhaust line is connected to an engine of the aircraft in order to supply fuel to the engine.

11. The fuel circulation system according to claim 7, characterized in that the admission line of the at least one diaphragm pump is connected to a tank, and the exhaust line is connected to an auxiliary power unit of the aircraft in order to supply fuel to the auxiliary power unit.

12. The fuel circulation system according to claim 7, characterized in that the admission line of the at least one diaphragm pump is connected to a tank, and the exhaust line is connected to an external source for receiving fuel in order to empty the tank.
